(19) United States
(12) Patent Application Publication
(10) Pub. No.: US 2016/0057136 A1
(43) Pub. Date: Feb. 25, 2016

(54) COMPUTER NETWORK SYSTEM WITH SINGLE-KEY QUICK SECURE LOGIN FUNCTION

(71) Applicant: Chi-Pei WANG, Hsinchu City (TW)

(72) Inventor: Chi-Pei WANG, Hsinchu City (TW)

(21) Appl. No.: 14/830,168

(22) Filed: Aug. 19, 2015

(30) Foreign Application Priority Data
Aug. 20, 2014 (TW) 103128551

(51) Int. Cl. H04L 29/06; H04L 9/32; G06F 21/34

(52) U.S. Cl. CPC H04L 63/0853; H04L 63/12; H04L 63/083; G06F 21/34; H04L 9/3234

(57) ABSTRACT

A computer network system with single-key quick secure login includes an end-use intelligent communication device with a control interface; an account number and password management software, executed in the communication device, encrypting and saving the account number and password data entered by the user; a login key, located in the control interface, so as to obtain and send out the encrypted account number and password data by single-key operation; a decryption server, decrypting the encrypted account number and password data; and an application server, receiving the account number and password data decrypted by the decryption server. Therefore, when the user wants to log in the application server, he presses the login key, the encrypted account number and password can be sent to the decryption server for decryption, so as to prevent the hackers from stealing the data entered by the user, and the login is quick and more convenient.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a computer network system, and more particularly to an innovative computer network system technology with single-key quick secure login function.

2. Description of Related Art Including Information Disclosed Under 37 CFR 1.97 and 37 CFR 1.98

In the course of transmitting computer keyboard keystroke data to the host computer, the keystroke data are public, as the software and hardware specifications of PC are public, anyone can use open software and hardware specifications or other methods to obtain the keystroke logging software and spy software to extract the user's keystroke data. The computer logging or spy software uses this characteristic to steal personal account numbers and passwords illegally.

At present, the complex network environment is very risky for the computer users without input data encryption products. It is often heard that computer game users have treasures or points in on-line games stolen, or the consumers suffer from monetary loss as the account number and password of online banking are logged. Therefore, the convenience of online banking transactions is restricted in various countries, for example, it is specified in Taiwan that the unappointed account number transfer should not exceed NTD30,000, some countries even disallow people to use online banking Even if the network uses cryptographic SSL (Secure Sockets Layer) or TLS (Transport Layer Security) encryption network protocol, the input data are not yet protected, and these encryption network protocols even help the hackers encrypt the stolen data and send them to their set locations.

At present, related circles have developed some computer anti-logging products, such as anti-logging keyboard, anti-logging software and anti-logging connecting wire for the consumers. Generally speaking, these known computer anti-logging products still have some problems and defects, the network decryption function is required. However, the decryption location of the known computer network system preventing input data from being logged must be in the application server (e.g. server of online banking), thus, the application server must change the original webpage and servo program to cooperate with the set process of encryption and decryption, so there are setup cost and control cost, so that the online bankers are unlikely to push the safety function of computer network system preventing the input data from being logged without other external pressures (e.g. imperative provisions), the online banking transaction is not safe enough, the users are unwilling to use online banking extensively, the bankers' online banking efficiency is not high, it cannot be a profitable tool for banks. The general users cannot use more convenient online banking functions (banks close some functions for reducing transaction risks); e.g. unappointed transfer (at present, most of banks require appointing the account at the bank counter before transfer).

On the other hand, when the online consumers enter account number and password data to log in the online banking, online shopping and on-line game websites, the user must enter the account number and password manually, it is apparently inconvenient. Certainly, in order to reduce the risks of assets loss, the user can set different account numbers and passwords for various banks, but it increases the difficulties and troubles in the user's memory. Eventually, the user sometimes cannot memorize them or forgets where they are, he uses the same and simple account number and password again.

Afterwards, related firms developed some application products for common people to save account number and password in the system and use an instruction to extract them, but they still may be intruded by a hacker. Therefore, they still lack security and practicability.

Thus, to overcome said problems of the prior art, it would be an advancement in the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

The “computer network system with single-key quick secure login function” disclosed in the present invention has the innovative unique structure form and technical characteristic formed by said end-use intelligent communication device with a control interface, account number and password management software, login key, decryption server and application server, compared with the (previous technology) proposed known structure, when the user wants to log in the application server, he only needs to press the login key, the encrypted account number and password can be sent from the end-use intelligent communication device to the remote decryption server for decryption, so as to prevent hackers from stealing the account number and password data entered by the user in the data transmission process, implementing computer input data anti-logging function and quick login, it is more convenient and practically evolutionary.

In addition, the computer network system has an end-use computer unit, which has an end-use software executing secure login action, and the application server has another technical characteristic of notifying the end-use computer unit of completed secure login of account number and password. When the encrypted account number and password are sent from the end-use intelligent communication device to the decryption server for decryption, and then to the application server, the application server notifies the end-use computer unit of the completed secure login of account number and password, so as to report the login message automatically.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is the three-dimensional schematic of a preferred embodiment of the present invention.

FIG. 2 is the three-dimensional schematic of another preferred embodiment of the present invention.

### DETAILED DESCRIPTION OF THE INVENTION

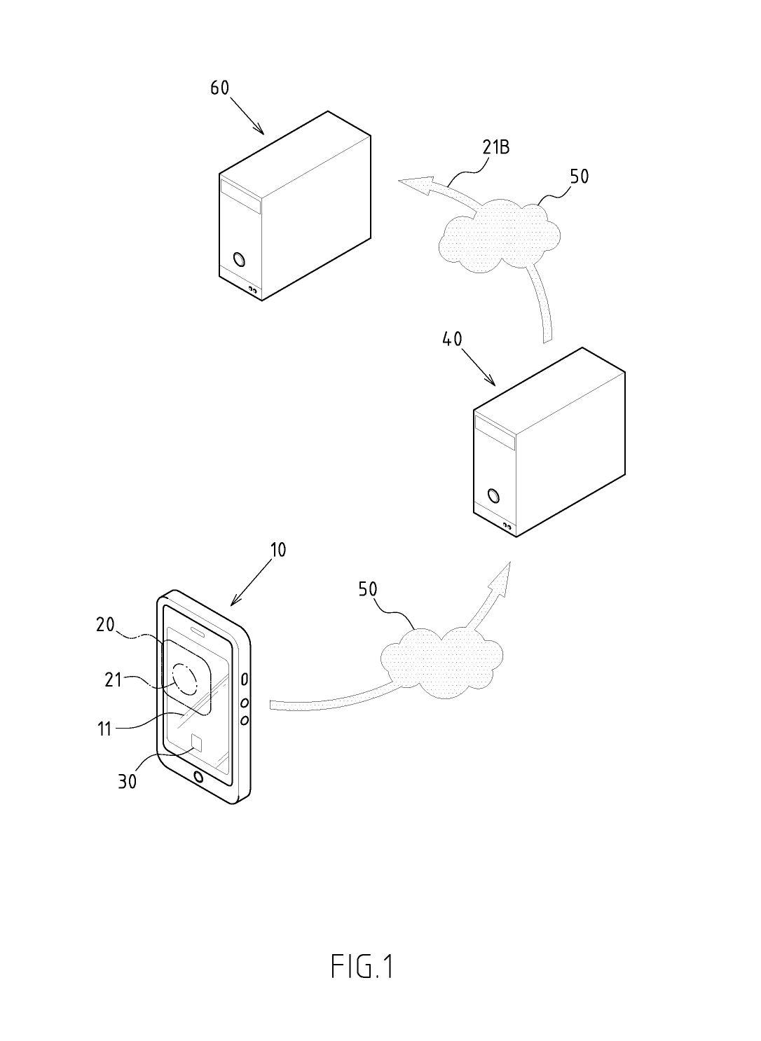

Referring to FIG. 1 for the preferred embodiment of the computer network system with single-key quick secure login function of the present invention, but this embodiment is for illustration only, not limited to this structure in patent application. Said computer network system comprises an end-use intelligent communication device 10, a control interface 11; an account number and password management software 20, executed in the end-use intelligent communication device 10, encrypting and saving the account number and password data 21 entered by user; a login key 30, located in the control interface 11 of end-use intelligent communication device 10, so as to obtain and send out said enciphered account number and password data 21 by single-key operation, the user does not need to reimport the account number and password; a decryption server 40, in data transmission connection relationship to end-use intelligent communication device 10 via internet 50. The decryption server 40 can decrypt the account number and password data 21 encrypted by the end-use intelligent communication device 10; an application server 60, in data transmission connection relationship to the decryption server 40 via internet 50 or private line network. The application server 60 can receive the account number and password data 21B decrypted by decryption server 40.

Based on the aforesaid technical characteristics, when the user wants to log in the application server 60, he presses the login key 30 on the control interface 11 of end-use intelligent communication device 10, the encrypted account number and password data 21 can be sent from the end-use intelligent communication device 10 to the remote decryption server 40 for decryption, so as to prevent the hackers from stealing the account number and password data 21 entered by the user in the data transmission process, implementing computer input data anti-logging function and quick login, it is more convenient.

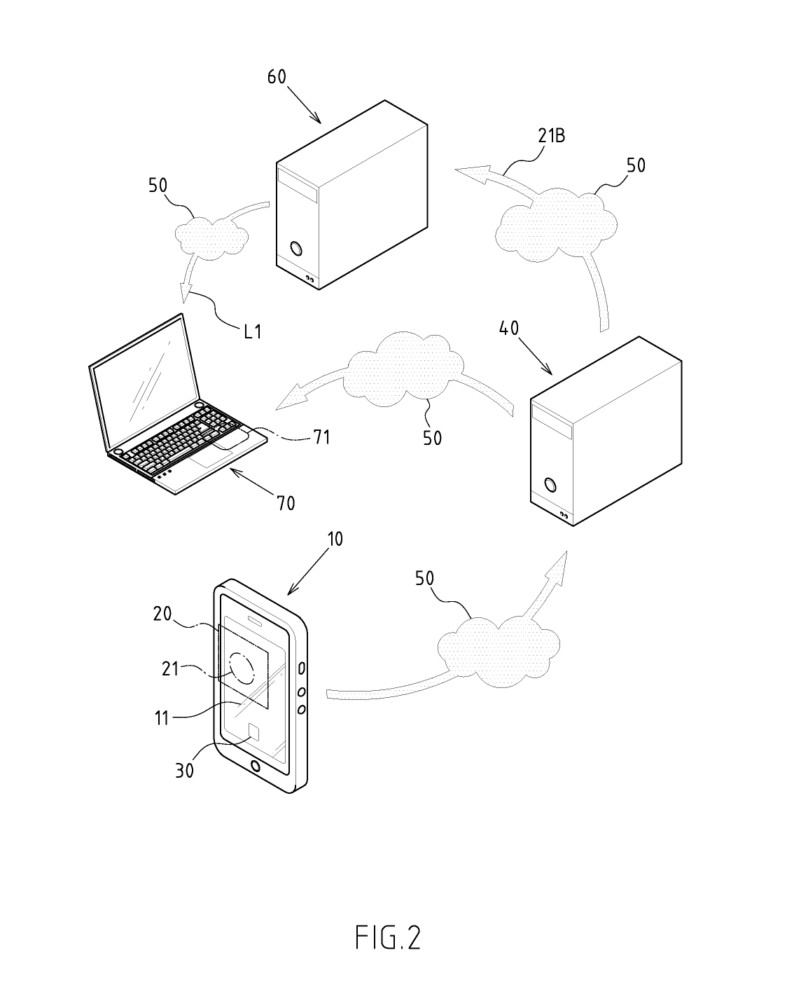

Referring to FIG. 2, said computer network system of the present invention also can comprise an end-use intelligent communication device 10, a control interface 11; an account number and password management software 20, executed in the end-use intelligent communication device 10, encrypting and saving the account number and password data 21 entered by user; a login key 30, located in the control interface 11 of end-use intelligent communication device 10, so as to obtain and send out said encrypted account number and password data 21 by single-key operation, the user does not need to enter the account number and password again; an end-use computer unit 70, with an end-use software 71 executing secure login action; a decryption server 40, in data transmission connection relationship to the end-use computer unit 70 via internet 50 and end-use intelligent communication device 10. The decryption server 40 can pair the end-use intelligent communication device 10 and end-use computer unit 70, and the decryption server 40 can decrypt the account number and password data 21 encrypted by end-use intelligent communication device 10; an application server 60, in data transmission connection relationship to the decryption server 40 via internet 50 or private line network. The application server 60 can receive the account number and password data 21B decrypted by decryption server 40; and the application server 60 can notify the end-use computer unit 70 of completed secure login of account number and password data 21B via internet 50.

According to said overall technical characteristic of another embodiment, when the user wants to log in the application server 60, he presses the login key 30 on the control interface 11 of the end-use intelligent communication device 10, the encrypted account number and password data 21 can be sent from the end-use intelligent communication device 10 to the remote decryption server 40 for decryption. Afterwards, the data are sent to the application server 60, the application server 60 notifies the end-use computer unit 70 of the completed secure login of account number and password data 21B (see Arrow L1 in FIG. 2), so as to prevent the hackers from stealing the account number and password data 21 entered by the user in the data transmission process, implementing computer input data anti-logging function and quick login, it is more convenient.

Said login key 30 can be any one of the following forms: real key, touch control electronic key (as shown in FIG. 1).

Said end-use intelligent communication device 10 includes mobile phone, tablet PC; said application server 60 can be online banking, online shopping and on-line game websites, where the users are required to enter data to log in.

The technical characteristic is formed, said decryption server 40 in the present invention is a medium for end-use intelligent communication device 10 to transmit account number and password data 21 to the application server 60. The account number and password data 21 imported by pressing the login key 30 on the control interface 11 of end-use intelligent communication device 10 is encrypted and exported, it is not decrypted in the end-use intelligent communication device 10, nor in the application server 60, but in the decryption server 40. The advantage of this technical characteristic is that the hackers cannot steal the literal data entered by the user, because the hackers steal data in the network process from the end-use intelligent communication device 10 to the decryption server 40, and the section from decryption server 40 to application server 60 is hard for hackers, so that the superexcellent computer input data anti-logging function is implemented. In addition, the present invention has said login key 30, the user can obtain and send said encrypted account number and password data 21 only by single-key operation. Thus, the user does not need to enter the account number and password manually, shortening the operating time of computer network data login greatly, it is easier, faster and more convenient.

I claim:

1. A computer network system with single-key quick secure login function comprises:
an end-use intelligent communication device with a control interface;
an account number and password management software, executed in the end-use intelligent communication device, so as to encrypt and save the account number and password data entered by the user;
a login key, located in the control interface of end-use intelligent communication device, so as to obtain and send out said encrypted account number and password data by single-key operation, the user does not need to enter the account number and password again;
a decryption server, in data transmission connection relationship to the end-use intelligent communication device via internet; the decryption server can decrypt the account number and password data encrypted by end-use intelligent communication device;
an application server, in data transmission connection relationship to the decryption server via internet or private line network; the application server can receive the account number and password data decrypted by the decryption server;
therefore, when the user wants to log in the application server, he presses the login key, the encrypted account number and password can be sent from the end-use intelligent communication device to the remote decryption server for decryption, so as to prevent the hackers from stealing the account number and password data entered by the user in the data transmission process, implementing computer input data anti-logging function and quick login, it is more convenient.

2. The system defined in claim 1, wherein said login key can be any one of the following forms: real key, touch control electronic key.

3. The system defined in claim 1, wherein said end-use intelligent communication device includes mobile phone and tablet pc; said application server is online banking, online shopping and on-line game websites, where the users are required to enter data to log in.

4. A computer network system with single-key quick secure login function comprises:
an end-use intelligent communication device with a control interface;
an account number and password management software, executed in the end-use intelligent communication device, so as to encrypt and save the account number and password data entered by the user;
a login key, located in the control interface of end-use intelligent communication device, so as to obtain and send out said encrypted account number and password by single-key operation, the user does not need to enter the account number and password again;
an end-use computer unit, with an end-use software executing secure login action;
a decryption server, in data transmission connection relationship to the end-use intelligent communication device and end-use computer unit via internet; the decryption server can pair the end-use intelligent communication device and end-use computer unit, and the decryption server can decrypt the account number and password data encrypted by the end-use intelligent communication device;
an application server, in data transmission connection relationship to the decryption server via internet or private line network; the application server can receive the account number and password data decrypted by the decryption server; the application server can notify the end-use computer unit of completed secure login of account number and password via internet;
therefore, when the user wants to log in the application server, he presses the login key, the encrypted account number and password can be sent from the end-use intelligent communication device to the remote decryption server for decryption, and then to the application server, the application server notifies the end-use computer unit of completed secure login of account number and password, so as to prevent the hackers from stealing the account number and password data entered by the user in the data transmission process, implementing computer input data anti-logging function and quick login, it is more convenient.

5. The system defined in claim 4, wherein said login key can be any one of the following forms: real key, touch control electronic key.

6. The system defined in claim 4, wherein said end-use intelligent communication device includes mobile phone and tablet pc; said application server is online banking, online shopping and on-line game websites, where the users are required to enter data to log in.
